(19) United States
(12) Patent Application Publication
(10) Pub. No.: US 2007/0180206 A1
(43) Pub. Date: Aug. 2, 2007

(54) Method of updating a duplicate copy of an operating system on the same disk

(76) Inventors: Julie Levell Craft, Austin, TX (US); Edward Shvartsman, Austin, TX (US)

Correspondence Address: IBM CORP (YA);C/O YEE & ASSOCIATES PC, P.O. BOX 802333, DALLAS, TX, 75380, US

(21) Appl. No.: 11/334,661

(22) Filed: Jan. 18, 2006

(51) Int. Cl. G06F 12/16

(52) U.S. Cl. 711/162

(57) ABSTRACT

A method, apparatus and computer usable program code for updating a duplicate copy of an active operating system. A set of logical volumes for an active operating system currently running on a data processing system is identified. The set of logical volumes is duplicated while the active operating system is running to form a duplicate copy of the active operating system. The duplicate copy of the active operating system is located on the same disk as the active operating system. This duplicate copy of the active operating system is updated while the active operating system is running to form an updated copy of the active operating system.

### BACKGROUND OF THE INVENTION

1. Field of the Invention:

The present invention is directed to a method and apparatus for updating a computer operating system. In particular, the present invention is directed to a method, apparatus, and computer usable program code for creating multiple instances of an operating system on the same hard disk.

2. Description of the Related Art:

A user may wish to create multiple copies of an operating system in order to update or modify the duplicate version of the operating system without altering the original operating system. A user may also wish to have an exact backup copy of the original operating system available for a fast recovery of the operating system in the event of a problem or failure in the original operating system. In addition, should the user determine that updates or modifications made to the original operating system are undesirable, a user may restore the original unmodified operating system using the duplicate backup copy.

A duplicate copy of an operating system can be created on a separate disk from the original operating system. However, a copy of the operating system located on a second disk can not share file systems from the original operating system. In addition, hard disks are becoming larger and, consequently, more costly to purchase by users. And most users have not yet moved from physical storage systems to virtual storage systems.

Some systems permit a user to create a duplicate copy of an operating system on the same hard disk as the original operating system by creating partitions on the disk. A partition on a hard disk drive is a sector of storage space dedicated to a particular operating system or application. A single partition may only house a single operating system. In order to have multiple instances of an operating system on a single hard drive, multiple partitions are created to divide the hard disk into a different partition segment for each instance of an operating system.

With partitioning, however, one instance of an operating system is unable to access shared file systems accessible to another instance of an operating system on the same hard disk. Additionally, one instance of an operating system cannot be updated from another instance of an operating system.

Moreover, some operating systems do not permit partitioning. These types of systems must continue to utilize at least two hard disks in order to create a duplicate copy of the operating system.

### SUMMARY OF THE INVENTION

The aspects of the present invention provide a computer implemented method, apparatus, and computer usable program code to update a duplicate copy of an active operating system. A set of logical volumes for an active operating system currently running on a data processing system is identified. The set of logical volumes is duplicated while the active operating system is running to form a duplicate copy of the active operating system. The duplicate copy of the active operating system is located on the same disk as the active operating system. This duplicate copy of the active operating system is updated while the active operating system is running to form an updated copy of the active operating system.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 depicts a pictorial representation of a data processing system in which the aspects of the present invention may be implemented;

FIG. 2 a block diagram of a data processing system is shown in which aspects of the present invention may be implemented;

FIG. 3 is an exemplary block diagram illustrating the interaction of multiple base operating system with logical volume manager in accordance with one embodiment of the present invention;

FIG. 4 depicts an exemplary block diagram illustrating a root volume group in accordance with one exemplary embodiment of the present invention;

FIG. 5 depicts an exemplary diagram illustrating a root volume group and partition table in accordance with one exemplary embodiment of the present invention;

FIG. 6 is an exemplary diagram of a root volume group containing an active operating system and a standby operating system in accordance with one exemplary embodiment of the present invention;

FIG. 7 is another exemplary diagram of a root volume group containing an active operating system and a standby operating system in accordance with one exemplary embodiment of the present invention;

FIG. 8 is a another exemplary diagram of a root volume group and a partition table in accordance with one embodiment of the present invention;

FIG. 9 is a flowchart outlining an exemplary operation of the present invention when a user implements multiple base operating system to create and update a standby operating system in accordance with one embodiment of the present invention;

FIG. 10 is an exemplary illustration of a pseudocode implementing multiple base operating system to create and update a standby operating system in accordance with one exemplary embodiment of the present invention;

FIG. 11 is a flowchart outlining an exemplary operation of the present invention when a commit operation is performed to remove a standby operating system copy in accordance with one exemplary embodiment of the present invention; and

FIG. 12 is an exemplary illustration of a pseudocode implementing a commit operation to remove a standby operating system copy in accordance with one exemplary embodiment of the present invention.

### DETAILED DESCRIPTION OF THE PREFERRED EMBODIMENT

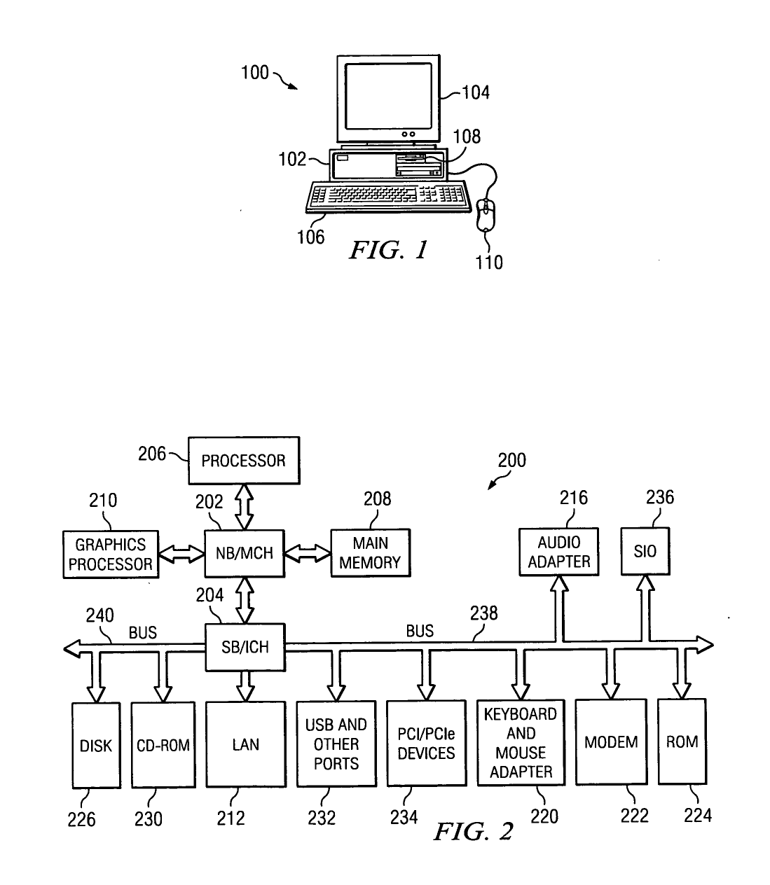

With reference now to the figures and in particular with reference to FIG. 1, a pictorial representation of a data processing system in which the aspects of the present invention may be implemented. A computer 100 is depicted which includes system unit 102, video display terminal 104, keyboard 106, storage devices 108, which may include floppy drives and other types of permanent and removable storage media, and mouse 110. Additional input devices may be included with personal computer 100, such as, for example, a joystick, touchpad, touch screen, trackball, microphone, and the like. Computer 100 can be implemented using any suitable computer, such as an IBM eServer computer or IntelliStation computer, which are products of International Business Machines Corporation, located in Armonk, N.Y. Although the depicted representation shows a computer, other embodiments of the present invention may be implemented in other types of data processing systems, such as a network computer. Computer 100 also preferably includes a graphical user interface (GUI) that may be implemented by means of systems software residing in computer readable media in operation within computer 100.

With reference now to FIG. 2, a block diagram of a data processing system is shown in which aspects of the present invention may be implemented. Data processing system 200 is an example of a computer, such as computer 100 in FIG. 1, in which code or instructions implementing the processes of the present invention may be located. In the depicted example, data processing system 200 employs a hub architecture including a north bridge and memory controller hub (MCH) 202 and a south bridge and input/output (I/O) controller hub (ICH) 204. Processor 206, main memory 208, and graphics processor 210 are connected to north bridge and memory controller hub 202. Graphics processor 210 may be connected to the MCH through an accelerated graphics port (AGP), for example.

In the depicted example, local area network (LAN) adapter 212 connects to south bridge and I/O controller hub 204 and audio adapter 216, keyboard and mouse adapter 220, modem 222, read only memory (ROM) 224, hard disk drive (HDD) 226, CD-ROM drive 230, universal serial bus (USB) ports and other communications ports 232, and PCI/PCIe devices 234 connect to south bridge and I/O controller hub 204 through bus 238 and bus 240. PCI/PCIe devices may include, for example, Ethernet adapters, add-in cards, and PC cards for notebook computers. PCI uses a card bus controller, while PCIe does not. ROM 224 may be, for example, a flash binary input/output system (BIOS). Hard disk drive 226 and CD-ROM drive 230 may use, for example, an integrated drive electronics (IDE) or serial advanced technology attachment (SATA) interface. A super I/O (SIO) device 236 may be connected to south bridge and I/O controller hub 204.

An operating system runs on processor 206 and coordinates and provides control of various components within data processing system 200 in FIG. 2. An object oriented programming system, such as the Java™ programming system, may run in conjunction with the operating system and provides calls to the operating system from Java programs or applications executing on data processing system 200 (Java is a trademark of Sun Microsystems, Inc. in the United States, other countries, or both).

Instructions for the operating system, the object-oriented programming system, and applications or programs are located on storage devices, such as hard disk drive 226, and may be loaded into main memory 208 for execution by processor 206. The processes of the present invention are performed by processor 206 using computer implemented instructions, which may be located in a memory such as, for example, main memory 208, read only memory 224, or in one or more peripheral devices.

Those of ordinary skill in the art will appreciate that the hardware in FIGS. 1 and 2 may vary depending on the implementation. Other internal hardware or peripheral devices, such as flash memory, equivalent non-volatile memory, or optical disk drives and the like, may be used in addition to or in place of the hardware depicted in FIGS. 1 and 2. Also, the processes of the present invention may be applied to a multiprocessor data processing system.

In some illustrative examples, data processing system 200 may be a personal digital assistant (PDA), which is configured with flash memory to provide non-volatile memory for storing operating system files and/or user-generated data. A bus system may be comprised of one or more buses, such as a system bus, an I/O bus and a PCI bus. Of course the bus system may be implemented using any type of communications fabric or architecture that provides for a transfer of data between different components or devices attached to the fabric or architecture. A communications unit may include one or more devices used to transmit and receive data, such as a modem or a network adapter. A memory may be, for example, main memory 208 or a cache such as found in north bridge and memory controller hub 202. A processing unit may include one or more processors or CPUs. The depicted examples in FIGS. 1 and 2 and above-described examples are not meant to imply architectural limitations. For example, data processing system 200 also may be a tablet computer, laptop computer, or telephone device in addition to taking the form of a PDA.

The aspects of the present invention provide an improved method, apparatus, and computer usable program code for creating, updating, and managing multiple instances of an operating system on the same hard disk. An operating system is a collection of programs located on a hard drive for controlling the operation of computers and networks of computers. The aspects of the presently claimed invention may be implemented with any operating system. Examples of various operating systems include UNIX® operating system, AIX® operating system, OS/2® (AIX and OS/2 are trademarks of IBM Corporation), DOS, Linux®, and Microsoft® Windows® XP (Microsoft and Windows are trademarks of Microsoft Corporation). In an illustrative embodiment of the present invention, the active operating system is an AIX® operating system.

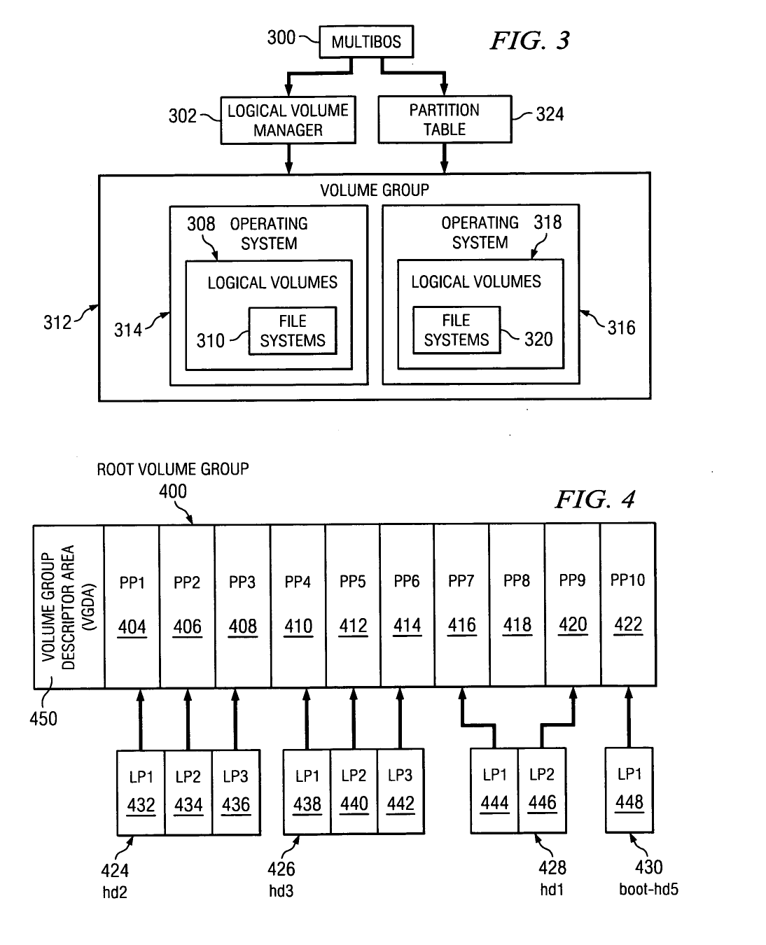

FIG. 3 is an exemplary block diagram illustrating the interaction of multiple base operating system with logical volume manager in accordance with one embodiment of the present invention. Multiple base operating system (multibos) 300 creates, updates, and manages multiple versions of an operating system on the same disk by calling logical volume manager 302 to create a duplicate copy of an instance of an operating system and updating a partition table to point to a boot image associated with an active operating system. An active operating system is the set of file systems and logical volumes that are currently running on a computer. In this example, the active operating system comprises logical volumes 308 and file systems 310. A computer will only boot from the active operating system or active boot image.

Logical volume manager 302 is a subsystem for managing disk storage that creates and manages logical volume sets in a logical volume group 312. Volume group 312 is a large storage pool in physical memory comprised of physical partitions allocated to logical volumes, such as logical volume 308, in volume group 312. Logical volume manager 302 creates volume group 312 and logical volumes 308 in volume group 312 by dividing physical memory into equal partitions and mapping physical partitions to logical volumes 308, as is discussed more fully below. Logical volumes 308 can store file systems 310, boot image, log devices, a system dump, or other data capable of storage on disk.

In accordance with the aspects of the present invention, multiple base operating system 300 creates a duplicate copy of operating system 314 by calling logical volume manager 302 to create a duplicate copy of logical volumes 308 and file systems 310 associated with operating system 314 to be copied. Multiple base operating system 300 also calls logical volume manager to create a boot image for the duplicate copy of the operating system. Duplicate copy of the operating system 316 is comprised of copied logical volumes 318 and file systems 320. Thus, a bootable duplicate copy of an operating system is created in the same volume group as the original operating system.

Partition table 324 points to a boot image associated with an operating system stored in volume group 312. When a user shuts down a computer system and reboots, the system will reboot in accordance with the boot image pointed to by partition table 324. When the system boots, firmware burned onto the computer calls nonvolatile random access memory (NVRAM) to check partition table 324 for a boot image. The boot image pointed to by partition table boots the operating system by mounting system files associated with the active operating system. The operating system associated with the booted operating system is the active operating system.

In accordance with one embodiment of the present invention, multiple base operating system 300 provides a command-line interface whereby a user enters commands at a prompt to interface with the processes of the present invention. However, the embodiments of the present invention are not limited to a command-line interface. Multiple base operating system may also be implemented in accordance with the aspects of the present invention via a graphical user interface (GUI), menu driven interface, other command-line interface, or any combination of interfaces implemented in accordance with the aspects of the present invention.

FIG. 4 is a block diagram of a root volume group in accordance with one exemplary embodiment of the present invention. A logical volume group is a grouping of logical volumes on a disk. A disk cannot contain more than one single logical volume group, although a logical volume group may span more than one disk.

Root volume group 400 is a large storage location in physical memory divided into physical partitions 404-422. Physical partitions are equal sized partitions created on the disk drive by logical volume manager that may store file systems, boot images, log files, system dump, of other data for an operating system or application stored on a disk. These physical partitions are grouped together to form logical volumes 424-430 in root volume group 400.

When logical volume manager creates logical volumes 424-430 in root volume group 400, logical volume manager maps logical partitions 432-448 to physical partitions 404-422. Logical partitions 432-448 appear contiguous when, in fact, physical partitions 404-422 may be scattered on the disk or actually even reside on multiple disks. For example, logical partitions 444 and 446 appear to be contiguous to an application, however, physical partitions PP7 416 and PP9 420 are not contiguous on the disk drive. Information and file systems may be stored in logical volume 428 as if physical partitions 416 and 420 were contiguous physical disk segments. The creation of logical volumes and volume groups is known in the prior art.

Volume group descriptor area 450 stores addresses for the locations of physical partitions 404-422 in physical memory. In other words, volume group descriptor area keeps track of where physical partitions begin and end. Volume group descriptor area also keeps track of which physical partitions map to each logical volume in root volume group 400.

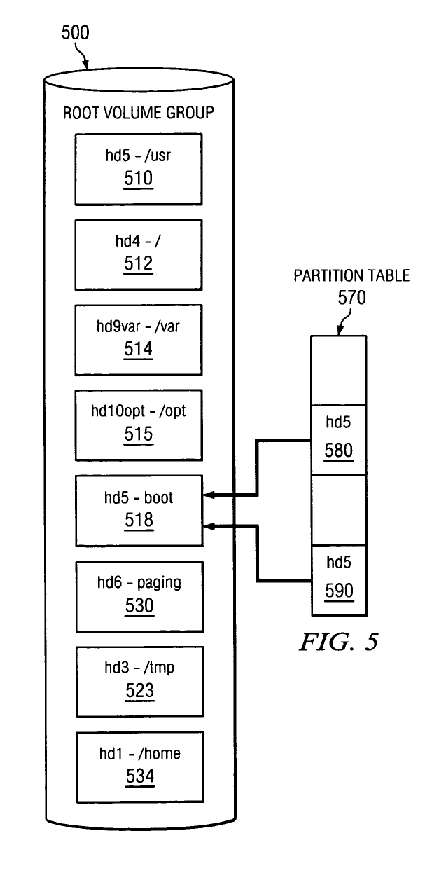

FIG. 5 is an exemplary diagram illustrating a root volume group (rootvg) and a partition table according to one exemplary embodiment of the present invention. Root volume group 500 contains logical volumes 510-534 associated with a single instance of an operating system on the disk.

In one embodiment of the present invention, root volume group 500 requires the entire memory space on a hard disk. However, as discussed above, root volume group may span more than one hard disk.

In this illustrative example, active operating system is the only instance of an operating system on root volume group 500. Logical volumes 510-534 store file systems and data associated with the active operating system, such as file systems(/usr) 510, (/)512, (/var) 514, (/opt) 516, (/tmp) 523, and (/home) 534.

Partition table 570 points to boot image stored in boot logical volume 518 associated with the active operating system. In this illustrative example, partition table pointers 580 and 590 point to a single boot image associated with active operating system.

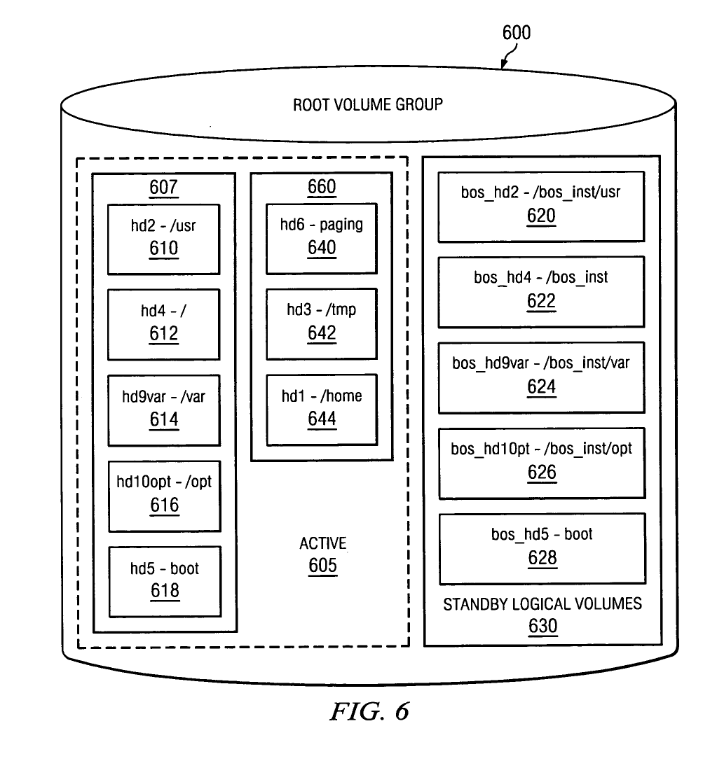

FIG. 6, is an exemplary diagram of a root volume group 600 containing an active operating system and a standby operating system in accordance with an embodiment of the present invention. Multiple instances of an operating system, such as active operating system 605, may be stored in a single root volume group 600 by duplicating a set of logical volumes 607, such as logical volumes 610-618, into standby logical volumes 620-628 in set of logical volumes 630 associated with a standby operating system.

Multiple instances of an operating system on a hard disk are defined herein to mean that there are at least two copies or versions of operating systems present on the same root volume group. A root volume group may span a single hard disk or multiple hard disks. Multiple instances of an operating system comprise a single active operating system and one or more versions of a standby operating system.

A standby operating system is an instance of an operating system that is not associated with the booted boot logical volume 618. In other words, a standby operating system is a version of an operating system that is not the active operating system. The standby operating system may be an exact duplicate copy of the active operating system or an updated version of the active operating system in these examples.

In one illustrative embodiment of the present invention, each instance of a standby operating system is a bootable copy of an operating system. In another exemplary embodiment of the present invention, at least two bootable instances of an operating system, the active operating system and one standby operating system, are located in the same root volume group. A standby operating system is created by identifying a set of logical volumes for the active operating system, such as logical volume set 607. The set of logical volumes 607 is a subset of logical volumes for the active operating system.

Logical volume set 607 is duplicated to form a duplicate copy of the active operating system on the same disk as the active operating system, such as standby logical volumes set 630. The duplicate copy of the operating system may then be updated without effecting active operating system.

Shared logical volumes are the remainder of logical volumes 640-644 in the plurality of logical volumes not copied into standby logical volumes 630. Active operating system has access to shared logical volumes 640-644 in logical volume set 660, such as paging space 640 and temporary space 642, on root volume group 600.

Applications and/or data in shared logical volumes 640-644 are only accessible to active operating system associated with the booted operating system. The active operating system has access to both shared logical volumes 660 and the set of logical volumes associated with the active operating system 605 on root volume group 600. Active operating system can access logical volumes 610-618 and shared logical volumes 640-644.

Standby logical volumes 620-628 are created with a specified prefix, such as bos_, identifying these logical volumes as standby logical volumes 630. In an illustrative embodiment, the duplicate copies of logical volumes are given a bos_prefix, such as bos_hd2 620, bos_-hd4 622, bos_hd9var 624, bos_hd10pt 626, and bos_hd5 628. Additional logical volumes, file systems, and paging space may also be specified to be copied to standby operating system. A duplicate copy of active operating system 670 logical volumes 610-618 in logical volume subset 607 is then made to standby logical volumes 620-628.

Multiple base operating system calls logical volume manager to create copies of logical volumes with a specified prefix, such as the bos_prefix, in response to a user request to copy an identified set of logical volumes to a standby copy. The copies of logical volumes with the specified prefix are standby logical volumes. Multiple base operating system then calls file system code to create and mount standby file systems with a specified prefix, such as the /bos_inst prefix. This prefix is used to distinguish active operating system file systems from operating system file systems. An example of a prefix is “/bos_inst”.

Multiple base operating system calls file system commands to copy active file systems associated with the duplicated logical volumes into the standby file systems. In an illustrative embodiment in FIG. 6, active file systems 610-618 are copied into standby file systems 620-628 with the file system names /bos_inst/usr 620, /bos_inst 622, /bos_inst/var 624, and /bos_inst/opt 626.

Shared logical volumes are the set of logical volumes that are not copied from active operating system to standby operating system. Shared logical volumes are accessible by any instance of an operating system in root volume group that is the active operating system. In other words, it is not necessary to copy shared logical volumes because shared logical volumes are available and accessible by any instance of an operating system that is the currently running operating system.

Boot partition table points to a boot logical volume for an operating system. The set of logical volumes for the operating system associated with the booted boot logical volume are the logical volumes for the active operating system. As is discussed in more detail below, a different active operating system may be created by calling multiple base operating system to update boot partition table to point to a boot image associated with the boot logical volume for a different bootable operating system on root volume group.

The standby operating system is an instance of an operating system that is not associated with a booted boot logical volume. As is illustrated in FIG. 6, standby copies of logical volumes 620-629 in logical volume subset 630 are associated with an instance of an operating system on root volume group 600 that is not the active operating system. Multiple standby operating systems may be located on a single root volume group.

Root volume group 600 has sufficient space to accommodate each standby operating system created on the same disk. In one embodiment of the present invention, the total number of copied logical volumes and shared logical volumes may be subject to volume group limitations to ensure that sufficient space is available on root volume group to accommodate standby logical volumes. For example, a limitation could be set such that the total number of copied logical volumes cannot exceed a specified number, such as a maximum of 128 copied logical volumes in a single root volume group.

In accordance with the aspects of the present invention, one instance of an operating system in the root volume group may be updated from another instance of an operating system in the same root volume group without interfering with the running active operating system. For example, user may update a duplicate copy of the active operating system without interfering with the original active operating system. An update to an operating system is defined as any update or modification to an operating system program code, including changing configurations, altering values, updating program code, adding a new program code, deleting an existing program code, updating an existing program code, or modifications to any part of an operating system program code.

Updates to an instance of an operating system may be accomplished utilizing a change root shell operation. In a shell operation, standby operating system file systems are mounted in the shell environment in order to provide access to standby file systems. The shell would simulate an environment in which the standby operating system operates as if it were running on the computer even though the standby operating system is not booted.

A user may update, modify, and test file systems within the shell environment. Active operating system files outside the shell may also be mounted over standby file systems in order to make the active operating system files visible within the shell. Data files may then be updated and tested within the shell environment. Implementation of a change root shell operation is known in the prior art.

In addition to updating a standby operating system, an exact backup copy of an operating system may be maintained on root volume group in order to initiate a fast and easy recovery of the original active operating system if there is a problem with the update to the operating system. Partition table may be updated to point to a different designated instance of an operating system, allowing a user to switch back and forth between different versions of an operating system. This process could be repeated as frequently as desired.

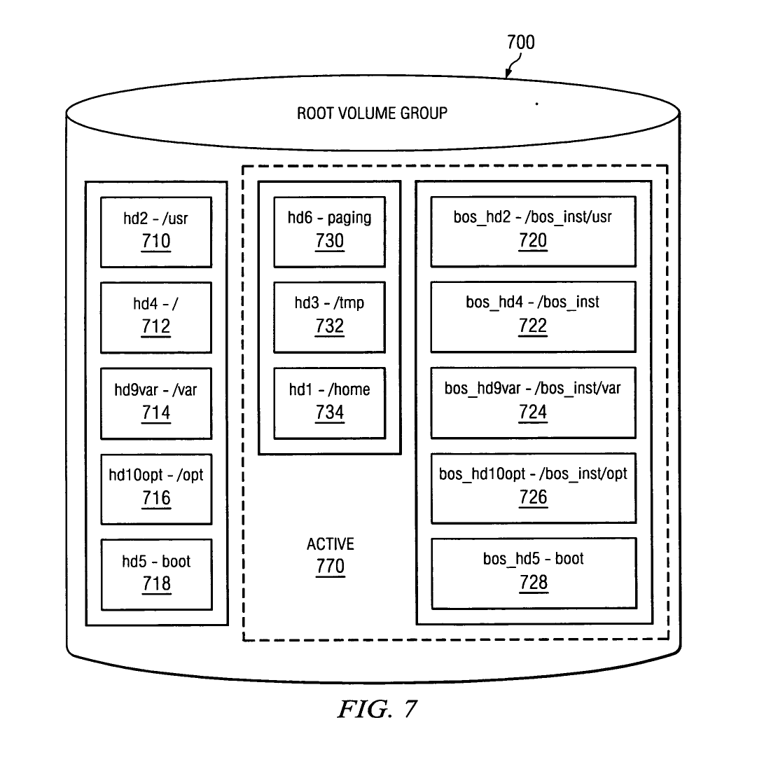

Referring to FIG. 7, another exemplary diagram of a root volume group 700 containing an active operating system and a standby operating system, when the user wants to replace the original active operating, such as active operating system 605 in FIG. 6, with a particular instance of a standby operating system, the user can call multiple base operating system to update partition table to point to a boot image for the selected standby operating system chosen to replace active operating system. User shuts down the system and initiates a reboot process to switch from original active operating system to selected standby operating system. Following the reboot process, the original active operating system is a standby operating system.

Logical volumes 710-718 associated with the original active operating system remain visible on root volume group after the original active operating system has been replaced as standby logical volumes. In other words, an exact bootable copy of the original active operating system remains on root volume group as standby logical volumes 710-718. Shared logical volumes 730-734 previously accessible to original active operating system 605 in FIG. 6 are now accessible to new active operating system 770. Active operating system 770 has access to logical volumes 720-728 and shared logical volumes 730-734.

If user wishes to restore the original active operating system user may call multiple base operating system to update boot partition to point back to boot image in boot logical volume 718. The system may then be shut down and rebooted using boot image associated with the original unmodified active operating system. Thus, user may initiate a fast and simple recovery of the active operating system.

A user may wish to change a boot partition for the same disk to point to the duplicate copy of the active operating system responsive to a failure in the set of logical volumes. A failure in the set of logical volumes is defined to include damage to the set of logical volumes, a failure in one or more logical volumes and/or file systems, or any failure of the active operating system to perform in accordance with a user's expectations.

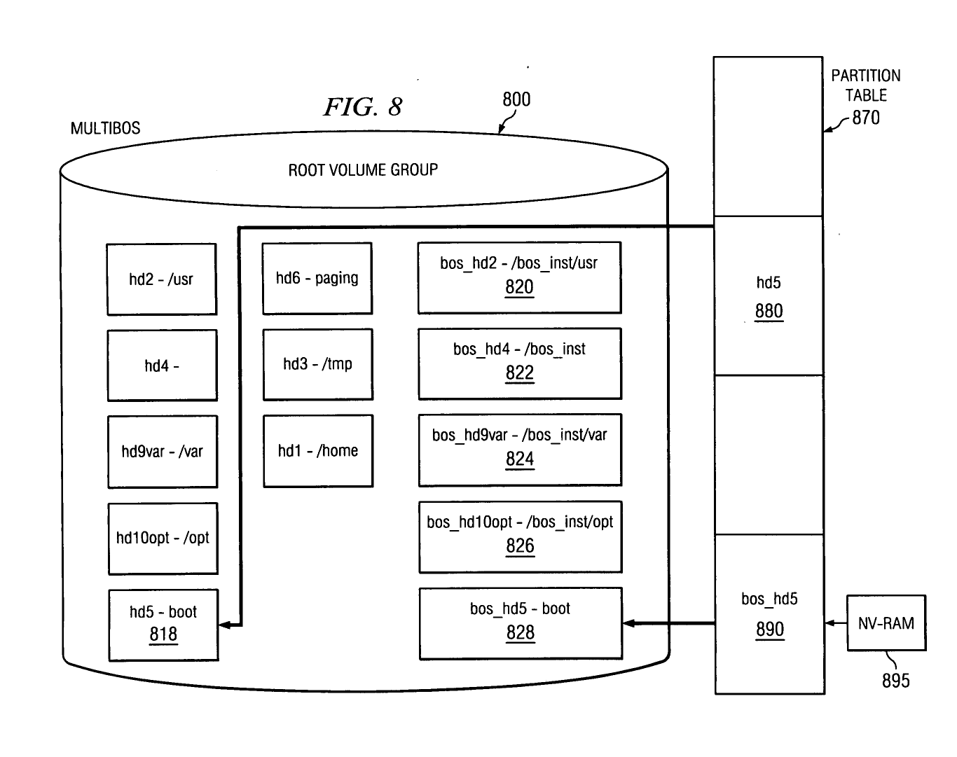

Referring to FIG. 8, another exemplary diagram of a root volume group and a partition table is depicted in accordance with an illustrative embodiment of the present invention. Partition table can point to multiple boot images, such as boot images hd5 880 and bos_hd5 890 associated with multiple instances of an operating system on root volume group. In this illustrative example, partition table 870 pointer 880 points to boot image for boot logical volume 818 associated with one instance of an operating system on root volume group 800. Pointer 890 points to boot image for boot logical volume 828 associated with another instance of an operating system on root volume group 800.

A user can initiate a boot process from any instance of an operating system by updating partition table 870 to point to the boot image for the selected standby operating system for the next reboot. In this illustrative example, pointer 880 points to boot image hd5 associated with boot logical volume 818 for the original active operating system. In other words, user has updated the boot process to point to a boot logical volume associated with the designated active operating system. A designated active operating system is any instance of an operating system selected to operate as an active operating system following the next reboot of the system.

If user desires to reboot the computer utilizing standby operating system rather than original active operating system, multiple base operating system is called to add pointer 890 to boot partition table 870. Pointer 890 points to boot image bos_hd5 associated with boot logical volume 828 for a standby operating system. NV-RAM 895 is updated to point to bos_hd5 890. When user shuts down the system and initiates a reboot process, the computer will boot up using the boot image pointed to by pointer 890. Control files for designated instance of the operating system, such as an /etc/filesystems file, will point the boot process to mount the standby operating system set of logical volumes, such as logical volumes 820-828, as the new active operating system file systems in place of the legacy set of logical volumes associated with the original active operating system that is being replaced.

The original active operating system becomes a standby operating system in root volume group. NV-RAM 895 may be updated again to point back to boot logical volume 818 associated with the original active operating system (now standby operating system) and initiate a reboot in order to restore the original operating system, if desired. In this manner, a user has the ability to initiate an easy and efficient recovery of the original active operating system if there is a problem with the update to the new active operating system.

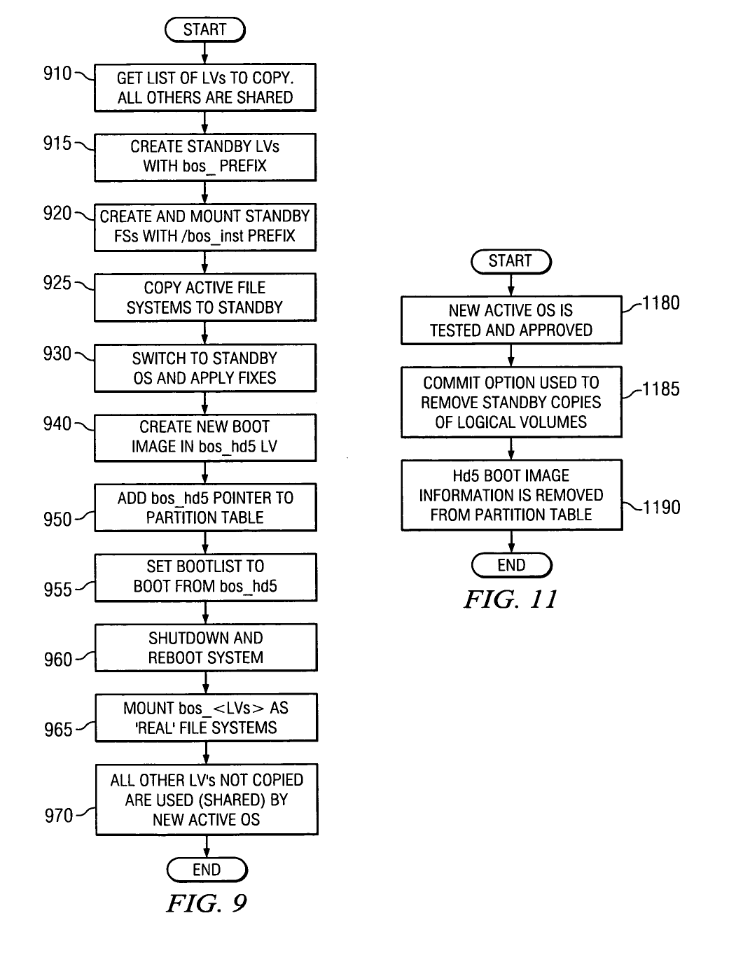

FIG. 9 a flowchart outlining an exemplary operation of the present invention when a user implements multiple base operating system to create and update a standby operating system in accordance with one embodiment of the present invention. The following process is implemented by multiple base operating system 300 in FIG. 3.

The process begins by multiple base operating system obtaining a list of the logical volumes to copy (step 910). In one embodiment of the present invention, a user identifies a set of logical volumes for the active operating system to copy. All other logical volumes associated with the instance of the operating system to be copied are shared logical volumes.

The multiple base operating system calls logical volume manager to create standby logical volumes with a specified prefix, such as the bos_prefix (step 915). For example, in accordance with one embodiment of the present invention, standby logical volumes with the following prefixes may be created: bos_hd2, bos_hd4, bos_hd9var, bos_hd10pt, and bos_hd5. The Multiple base operating system creates and mounts standby file systems with a specified prefix (step 920), such as /bos_inst prefix. For example, standby file systems may be created such as /bos_inst, /bos_inst/usr, /bos_inst/var, and /bos_inst/opt 720-728 in FIG. 7.

Next, the multiple base operating system copies file systems associated with the active operating system to standby logical volumes (step 925). A switch to standby operating system is made and updates, and/or fixes are applied to standby operating system (step 930). A switch to standby operating system may be accomplished by mounting an update directory in the /bos_inst file system and creating an interactive change root shell with standby operating system file systems. In this environment, data files may be changed and updates may be applied and tested.

If updates are successful and user wants to replace the old active operating system with standby operating system, multiple base operating system creates a new boot image in boot logical volume associated with standby operating system (step 940). Multiple base operating system adds a pointer to partition table to point to the boot image for standby operating system (step 950). Multiple base operating system may then set bootlist, which updates NV-RAM to boot from the boot image associated with standby operating system designated to be the new active operating system (step 955). The system may be shutdown by user and rebooted (step 960) in accordance with the boot image associated with the new active operating system.

Boot image will mount logical volumes associated with new active operating system as the real file systems for new active operating system (step 965). In the example provided in FIG. 7, logical volumes mounted as active operating system logical volumes are bos_hd2 (/usr), bos_hd4(/), bos_hd9var (/var), bos_hd10opt (/opt), and bos_hd5 (boot).

Referring back to FIG. 9, other logical volumes not copied by logical volume manager are accessible to the new active operating system. The new active operating system can access and use these shared logical volumes (step 970). Original active operating system becomes a standby operating system in root volume group and is available if a recovery of original active operating system is necessary.

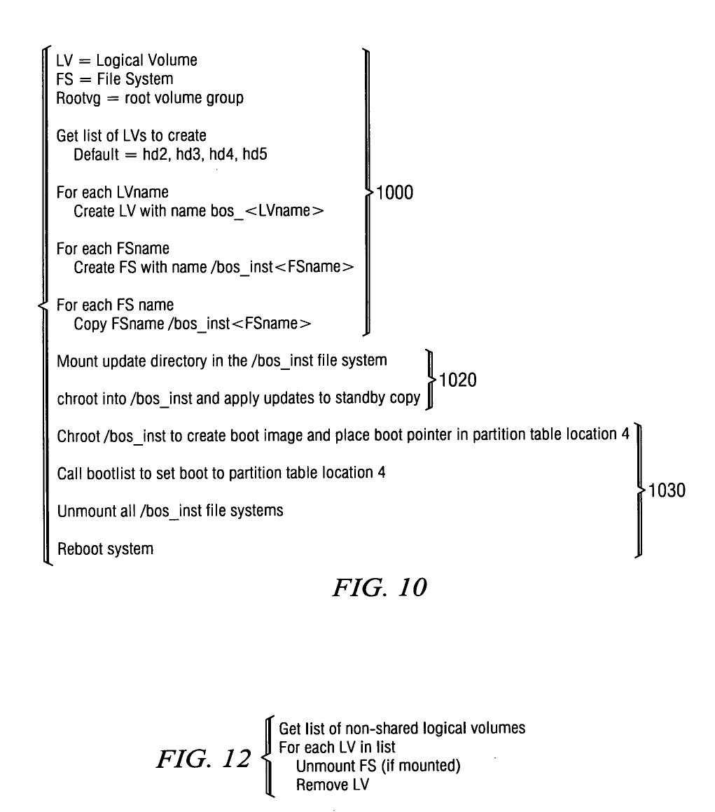

FIG. 10 is an example of a pseudocode for implementing multiple base operating system to create and update a standby operating system in accordance with an illustrative embodiment of the present invention. The process for creating and updating a standby operating system may be implemented utilizing any programming language according to the pseudocode as shown in FIG. 10. Pseudocode 1000 illustrates the logic for creating duplicate logical volumes and file systems for the standby operating system. Pseudocode 1020 illustrates the logic for mounting standby operating system files in a change root environment and applying updates to standby operating system. A new boot image is created and bootlist updated to point to standby operating system boot image according to pseudocode 1030.

FIG. 11 is a flowchart outlining an exemplary operation of the present invention when multiple base operating system performs a commit operation to remove a standby operating system in accordance with one embodiment of the present invention. The process starts after the operating system has been tested and approved by the user. Then the last two steps are implemented by multiple base operating system 300 in FIG. 3.

Prior to removing a standby instance of an operating system, the active operating system should be tested and approved by a user (step 1180). Multiple base operating system can then be called to perform a commit option to remove standby copies of logical volumes associated with the standby operating system to be removed (step 1185). In one embodiment, multiple base operating system performs verification on each standby object before removing the standby object. Any mounted standby boot logical volumes are unmounted and standby file systems are removed. Multiple base operating system then removes any remaining standby logical volumes.

Multiple base operating system removes boot image information, such as hd5 boot image information, for the instance of the standby operating system from partition table (step 1190). In one embodiment, the bootlist is set to the active boot logical volume after all boot references to standby boot image are removed from partition table.

The aspects of the present invention avoid the expense of purchasing additional hard disks for copying an operating system. In addition, a user may preserve a duplicate copy of the operating system on the same disk to ensure that if an update to the active operating system is a failure, the original operating system as it existed prior to the update can be easily recovered.

After new active operating system is verified and approved, standby operating system may be removed from root volume group by performing a commit operation. FIG. 12 is an example of the pseudocode implementing multiple base operating system to perform a commit operation according to one exemplary embodiment of the present invention. The process of performing a commit operation may be implemented utilizing any programming language in accordance with the psuedocode as shown in FIG. 12.

A commit operation to remove a particular instance of a standby operating system in root volume group is accomplished in one embodiment of the present invention by first identifying a list of non-shared logical volumes associated with the particular instance of a standby operating system to be removed from root volume group. Shared logical volumes will remain in root volume group for accessing by active operating system. Any mounted file systems are unmounted for each logical volume in the list of non-shared logical volumes associated with the standby operating system to be removed. Multiple base operating system removes non-shared logical volumes associated with the instance of the standby operating system to be removed from root volume group. Multiple base operating system also removes boot image information associated with the standby operating system from partition table. Partition table may be updated by multiple base operating system to point to boot image information associated with an instance of an operating system designated to be the new active operating system.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems which perform the specified functions or acts, or combinations of special purpose hardware and computer instructions.

The invention can take the form of an entirely hardware embodiment, an entirely software embodiment or an embodiment containing both hardware and software elements. In an illustrative embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A computer implemented method for updating a duplicate copy of an active operating system, the computer implemented method comprising:
identifying a set of logical volumes for the active operating system currently running on a data processing system;
duplicating the set of logical volumes while the active operating system is running to form the duplicate copy of the active operating system, wherein the duplicate copy of the active operating system is located on a same disk as the active operating system; and
updating the duplicate copy of the active operating system while the active operating system is running to form an updated copy of the active operating system.

2 The computer implemented method of claim 1 further comprising:
changing a boot partition to point to the updated copy of the active operating system, wherein the updated copy of the active operating system becomes the active operating system running on the data processing system.

3. The computer implemented method of claim 1, wherein the set of logical volumes is a subset of logical volumes for the active operating system.

4. The computer implemented method of claim 1 further comprising:
responsive to a failure in the set of logical volumes, changing a boot partition for the same disk to point to the duplicate copy of the active operating system.

5. The computer implemented method of claim 1, wherein the set of logical volumes are in a root volume group.

6. The computer implemented method of claim 5, wherein at least two bootable instances of an operating system are located in the root logical volume.

7. The computer implemented method of claim 1, further comprising:
updating a boot process to point to a boot logical volume associated with a designated active operating system.

8. The computer implemented method of claim 5, wherein the active operating system has access to a set of shared logical volumes on the root volume group.

9. The computer implemented method of claim 1, wherein the step of duplicating the set of logical volumes to from the duplicate copy of the active operating system further comprises:
creating copies of logical volumes with a specified prefix.

10. A computer program product comprising:
a computer usable medium including computer usable program code for updating a duplicate copy of an active operating system, said computer program product comprising:
computer usable program code for identifying a set of logical volumes for the active operating system;
computer usable program code for duplicating the set of logical volumes to form the duplicate copy of the active operating system, wherein the duplicate copy of the active operating system is located on a same disk as the active operating system; and
computer usable program code for updating the duplicate copy of the active operating system.

11. The computer program product of claim 10, further comprising changing a boot partition to point to the updated copy of the active operating system, wherein the updated copy of the active operating system becomes the active operating system running on the data processing system.

12. The computer program product of claim 10, wherein the set of logical volumes are a subset of logical volumes for the active operating system.

13. The computer program product of claim 10, further comprising responsive to a failure in the set of logical volumes, changing a boot partition for the same disk to point to the duplicate copy of the active operating system

14. The computer program product of claim 10, wherein the set of logical volumes are in a root volume group.

15. The computer program product of claim 14, wherein at least two bootable instances of an operating system are located in the root logical volume.

16. The computer program product of claim 10, further comprising updating a boot process to point to a boot logical volume associated with a designated active operating system.

17. The computer program product of claim 14 wherein the active operating system has access to a set of shared logical volumes on the root volume group.

18. The computer program product of claim 10 wherein duplicating the set of logical volumes to form the duplicate copy of the active operating system further comprises creating copies of logical volumes with a specified prefix.

19. An apparatus for updating a duplicate copy of an active operating system, comprising:
a storage device connected to a bus, wherein the storage device contains a computer usable program product;
a processor, wherein the processor unit executes the computer usable program code to identify a set of logical volumes for the active operating system;
duplicate the set of logical volumes to form the duplicate copy of the active operating system, wherein the duplicate copy of the active operating system is located on a same disk as the active operating system; and
update the duplicate copy of the active operating system.

20. The apparatus of claim 17, further comprising changing a boot partition to point to the updated copy of the active operating system, wherein the updated copy of the active operating system becomes the active operating system running on the data processing system.
